(19) United States
(12) Patent Application Publication
(10) Pub. No.: US 2014/0324409 A1
(43) Pub. Date: Oct. 30, 2014

(54) STOCHASTIC BASED DETERMINATION

(71) Applicant: HEWLETT-PACKARD DEVELOPMENT COMPANY, L.P., Houston, TX (US)

(72) Inventors: Yonatan Ben Simhon, Netanya (IL); Yaneeve Shekel, Tel Aviv (IL); Ira Cohen, Modiin (IL); Ohad Assulin, Neve Ilan (IL)

(73) Assignee: Hewlett-Packard Development Company, L.P., Houston, TX (US)

(21) Appl. No.: 13/873,790

(22) Filed: Apr. 30, 2013

(51) Int. Cl. G06F 11/34

(52) U.S. Cl. CPC G06F 11/3447
USPC 703/22

(57) ABSTRACT

Stochastic based determination can include accessing a sequence of a plurality of vectors, wherein each of the plurality of vectors includes a plurality of metrics that define a performance of an application. Stochastic based determination can also include querying a digital representation of a first Stochastic Model to determine a first likelihood that the sequence will terminate in an anomalous state. Stochastic based determination can include querying a digital representation of a second Stochastic Model to determine a second likelihood that the sequence will terminate in a normal state. Stochastic based determination can include determining whether the sequence will terminate in the anomalous state based on a comparison between the first likelihood and the second likelihood.

### BACKGROUND

Problem identification in an Information Technology (IT) system can include detecting a problem. Problem detection can include gathering data and analyzing the data. The manifestations of problems associated with IT systems can cause downtime in the IT system. Downtime can affect the functionality of the IT system. Reducing the downtime associated with problems can increase IT system functionality.

### BRIEF DESCRIPTION OF THE DRAWINGS

FIG. 1 is a diagram illustrating an example of a sequence according to the present disclosure.

FIG. 2A is a diagram illustrating an example of Stochastic based determination according to the present disclosure.

FIG. 2B is a diagram illustrating an example of Stochastic based determination according to the present disclosure.

FIG. 3A is a diagram illustrating an example of a topology of an application according to the present disclosure.

FIG. 3B is a diagram illustrating an example of a topology of an application according to the present disclosure.

FIG. 4 is a flow chart illustrating an example of a method for Stochastic based determination according to the present disclosure.

FIG. 5 is a diagram illustrating an example of a computing device according to the present disclosure.

### DETAILED DESCRIPTION

In a number of previous examples, a Stochastic Model has been used to classify a number of observations. That is, a single Stochastic Model has been used to classify the observations. Furthermore, previous examples have used a Stochastic Model, e.g., Hidden Markov Models, to classify observations that are associated with natural language processing. In contrast, a number of examples of the present disclosure, use a plurality of Stochastic Models to predict and/or classify problems that are associated with Information Technology (IT) systems. Using a plurality of Stochastic Models can provide greater accuracy over using a single Stochastic Model. Furthermore, using Stochastic Models to predict rather than classify can provide for an early alert system that can be used to resolve problems faster than a classification based problem detection system.

As used herein, a metric can define a measurement that is associated with an application. A measurement that is associated with an application can be a representation of a state that is associated with an application. For example, a central processing unit (CPU) usage can be a measurement that represents the state of the CPU wherein the application can be associated with the CPU. In a number of examples, a metric can be a CPU usage, a bandwidth usage, and/or a memory usage, among other measurements.

A plurality of metrics can define the performance of an application at a given time and/or time interval. By way of example, a plurality of metrics can include CPU usage, memory usage, and bandwidth usage. The plurality of metrics can be grouped into a vector, which can define the performance of the application at a given time and/or time interval. For example, a vector can include a value for the CPU usage, the memory usage, and the bandwidth usage at the given time and/or time interval. A plurality of vectors can be grouped into a sequence, e.g., over more than one time and/or time interval.

A time can be different from a time interval in that a time interval covers a range of times while a time is a single reference point in time. A time interval can be defined by a beginning time and an ending time. For example, a time interval can begin at 12:00 p.m. and can end at 12:01 p.m. In a number of examples, a time interval can be defined by a duration of time. For example, a time interval can be a minute, an hour, or a day, among other examples of a time interval.

A sequence can be used to predict whether an application will experience a loss of function sufficient to send Information Technology (IT) personnel an alert of the loss of function, e.g., problem. A prediction can be created from two Stochastic Models. A Stochastic Model is a statistical method that can be used to predict an outcome. A Stochastic Model can be a Hidden Markov Model, for example. A first Stochastic Model, e.g., first Hidden Markov Model, can be used to predict whether an application will encounter a problem with a first specific likelihood, e.g., a problem. A second Stochastic Model, second Hidden Markov Model, can be used to predict whether an application will not encounter a problem with a second specific likelihood, e.g., a normal result. A prediction that the application will encounter a problem can be used as an early detection to prevent and/or resolve the problem.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

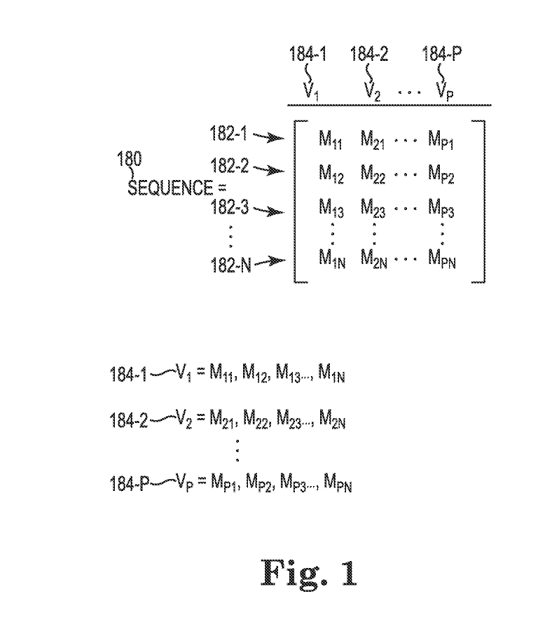

FIG. 1 is a diagram illustrating an example of a sequence according to the present disclosure. FIG. 1 includes a sequence 180 with a number vectors and a number of metrics.

As used herein a sequence 180 can be composed of a vector 184-1, a vector 184-2, . . . , and a vector 184-P, e.g., referred to generally as vectors 184. Each of the vectors can be composed of individual instances of a plurality of metrics. For example, a vector 184-1 can be composed of an instance of metric 182-1, e.g., M₁₁, an instance of metric 182-2, e.g., M₁₂, an instance of metric 182-3, e.g., M₁₃, . . . , and an instance of metric 182-N, e.g., M_{1N}, e.g., referred to generally as metrics 182. As used herein, a metric can be used to refer to an instance of a metric. That is, the term instance of a metric and metric are used interchangeably.

As described previously, a metric can be measurement that is associated with an application. For example, a metric can be packets dropped and CPU temperature, among other metrics. Each of the instances of a metric can define a measurement at a given time and/or during a given time interval. For example, metric 182-1 can be a CPU temperature and a metric 182-2 can be the number of packets dropped. For instance, M₁₁ which is an instance of metric 182-1 can define the mean temperature of a CPU during a first time interval while M₂₁, which is also an instance of metric 182-1, can define the mean temperature of a CPU during a second time interval. Furthermore, M₁₂ which is an instance of metric 182-2 can define the packets dropped during the first time interval while M₂₂ which is also an instance of metric 182-2 can define the packets dropped during the second time interval.

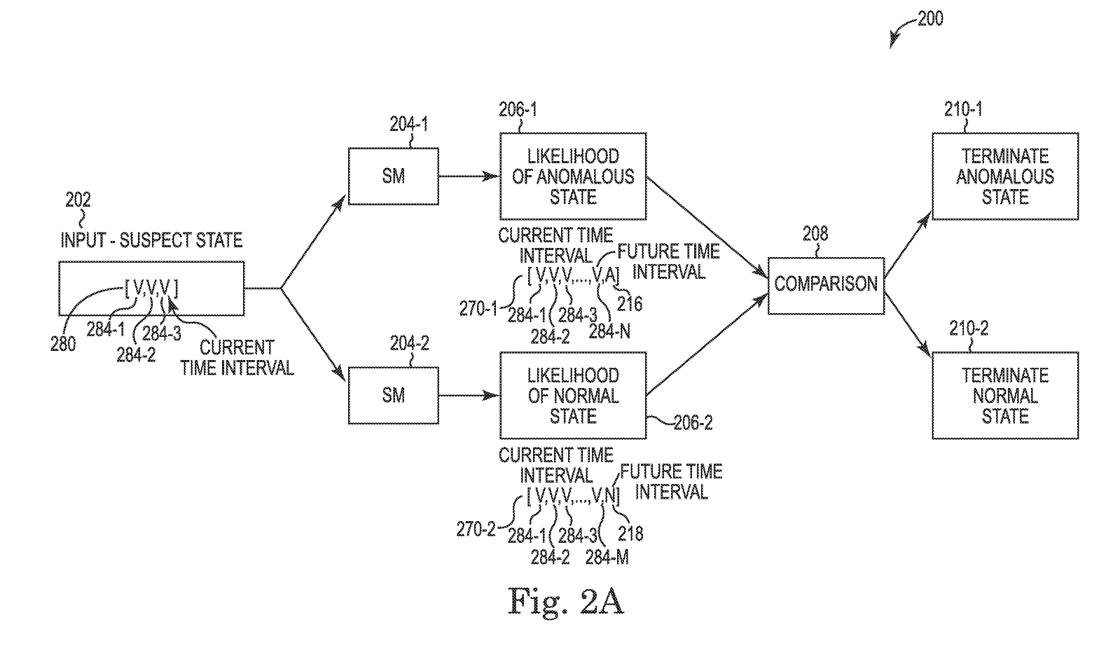

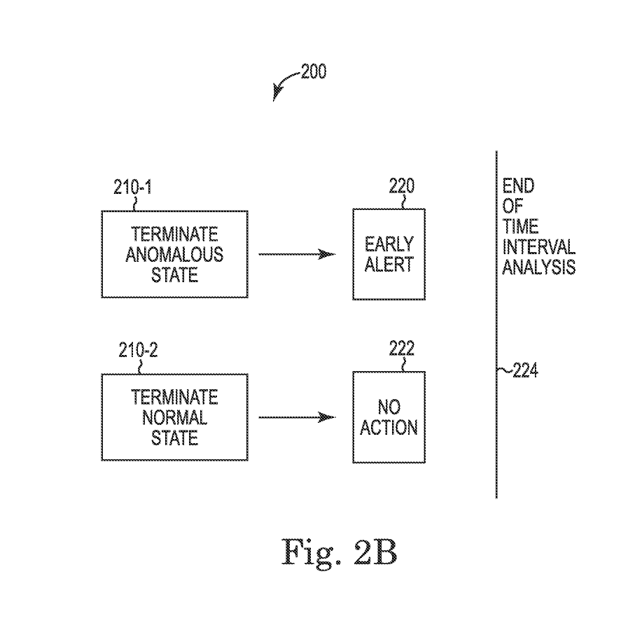

FIG. 2A is a diagram illustrating an example of Stochastic based determination according to the present disclosure. FIG. 2A includes time interval analysis 200, an input 202, a first Stochastic Model 204-1, a second Stochastic Model 204-2, a likelihood of an anomalous state 206-1, and a likelihood of a normal state 206-2, a comparison 208, a determination of an anomalous state 210-1, and a determination of a normal state 210-2.

An IT system can produce and/or provide a sequence 280. For example, a sequence 280 can include a vector 284-1, a vector 284-2, and a vector 284-3, however examples are not limited to a particular number of vectors. The sequence 280 can define a performance of an application. As used herein, an application can be machine readable instructions and/or hardware, e.g., processor, memory, and/or other hardware components.

An application can be monitored and the monitoring of the application can produce a number of metrics. For example, a computing device can monitor an application wherein the computing device can create a number of metrics based on the performance of the application and/or based on the performance of a number of components that are associated with the application. The metrics produced by the computing device can be used to create vectors that can be used to create a sequence 280.

A number of components can be associated with an application when the application is dependent on the components. As used herein, a component can be hardware and/or machine readable instructions, e.g., software, which performs a function upon which the application relies. For example, hardware components such as a server can be associated with the application. Components can be monitored to create metrics that can define the performance of the application.

The sequence 280 can be associated with a time interval. For example, the vector 284-1 can be associated with a first time interval, the vector 284-2 can be associated with a second time interval, and the vector 284-3 can be associated with a third time interval. A first time interval can be from 12:00 to 12:01, a second time interval can be from 12:01 to 12:02, a third time interval can be from 12:02-12:03, for instance. In a number of examples, the last time interval, e.g. third time interval, can represent a current time interval and/or the latest time interval for which metrics and/or vectors are available.

The sequence 280 can be classified into a state. For example, the sequence 280 can be classified into a normal state, a suspect state, or an anomalous state. The sequence 280 can be classified into more and/or less states than those described herein.

A normal state can be defined by an expected function and/or performance of an application. A normal state can also be defined by the expected function and/or performance of the components that are associated with the application. For example, if an application is functioning as expected and the components that are associated with the application are functioning as expected then a sequence that describes the performance of the application can be classified into a normal state.

A suspect state can be defined by a non-expected function and/or performance of an application. A suspect state can also be defined by a non-expected function and/or performance of the components that are associated with the application. The function and/or performance of an application and/or components that are associated with the application can be considered a non-expected function when the function and/or performance is outside an expected range of the function and/or performance. For example, if a CPU usage has an expected range of 20%-95% usage, then a non-expected function and/or performance of an application can exist when a CPU that is associated with an application functions and/or performs at 99% usage. Furthermore, a suspect state can include non-expected functions that are not reported to IT personnel, e.g., a user, and/or to other IT system components. That is, a suspect state can represent behavior that is suspect but does not amount to a problem that limits the function of an application.

An anomalous state can be defined by a non-expected function that is a problem that is associated with the application and/or the components that are associated with the application. Anomalous states are reported to IT personnel and/or other IT system components. For example, a sequence can be classified as an anomalous state when a non-expected function that is a problem exists and when the non-expected function is reported to IT personnel and/or other IT system components. As used herein, IT personnel and/or other IT system components can include a detection and/or monitoring module that is associated with an IT system.

A sequence 280 can progress from a normal state to a suspect state when, for example, the plurality of metrics in the plurality of vectors 284 in the sequence 280 are greater than or less than a threshold. The plurality of metrics can be greater than or less than a threshold when any metric is greater and/or less than the threshold. In a number of examples, the plurality of metrics can be greater than or less than a threshold when any combination of the metrics is greater and/or less than the threshold. Other examples can exist that portray how the plurality of metrics can be greater than or less than a threshold.

As used herein, a sequence 280 can be a partial sequence or a terminated sequence. A partial sequence can be a sequence that has not terminated in either an anomalous or a normal state. A partial sequence can be a sequence that has not been classified as an anomalous state or a normal state. A terminated sequence can be a sequence that has terminated as either an anomalous state or a normal state and/or has not been classified as an anomalous state or a normal state. That is, the classification of a sequence 280 can determine whether the sequence 280 is partial sequence or terminated sequence.

In a number of examples, a partial sequence can be partial based on the number of vectors in the sequence. For example, the sequences 280 can be partial if the standard for a terminated sequence is a sequence with four vectors because the number of vectors, e.g., 284-1, 284-2, and 284-3, in the sequence 280 is three.

The sequence 280 can be used to query a digital representation of a first Stochastic Model 204-1 and a digital representation of a second Stochastic Model 204-2 to determine the likelihood that the sequence 280 will terminate in an anomalous state or a normal state, respectively. As used herein, the terms a digital representation of a first Stochastic Model and a Stochastic Model are used interchangeably. A likelihood can be expressed as a percentage, a score, and/or a number, among other types of expressions of a likelihood. A likelihood can express how sure the first Stochastic Model 204-1 is that the sequence 280 will terminate in an anomalous state and how sure the second Stochastic Model 204-2 is that the sequence 280 will terminate in a normal state.

In a number of examples, a Stochastic Model can be a Hidden Markov Model. As used herein, a Stochastic Model, e.g., Hidden Markov Model, is a statistical model that is used to evaluate the sequence 280 to determine the likelihood that the sequence will terminate in a given state. The sequence that will terminate in a given state, e.g., anomalous state and/or normal state, may be modeled as a probabilistic function of an underlying Markov chain having state transitions that are not directly observable. An Hidden Markov Model can use the Baum-Welch algorithm to find the unknown parameters of the Hidden Markov Model. The Baum-Welch algorithm can use the forward-backward algorithm which computes the posterior marginals of all hidden state variables given a number of sequences that formulate a history of sequences.

For example, the digital representation of the first Stochastic Model 204-1 and the digital representation of the second Stochastic Model 204-2 can be queried to determine the likelihood that the sequence 280 will terminate in an anomalous state or a normal state, respectively. The first Stochastic Model 204-1 can express a likelihood 206-1 that the sequence 280 will progress into a future sequence 270-1, wherein the sequence 280 is included in the future sequence 270-1 and wherein the future sequence 270-1 includes predictions of a number of future vectors, e.g., vector 284-N, that will terminate in an anomalous state 216. The future vectors, e.g., vector 284-N, can be used to determine if the classification was correctly assigned. The second Stochastic Model 204-2 can express a likelihood 206-2 that the sequence 280 will progress into a future sequence 270-2, wherein the sequence 280 is included in the future sequence 270-2 and wherein the future sequence 270-2 includes predictions of a number of future vectors, e.g., vector 284-M, that will terminate in a normal state.

The likelihood 206-1 of an anomalous state can be compared 208 to the likelihood 206-2 of a normal state. The comparison can be used to determine 210-1 whether the sequence 280 will terminate in an anomalous state or to determine 210-2 whether the sequence 280 will terminate in a normal state. That is, a determination 210-1 that the sequence 280 will terminate in an anomalous state can be a prediction that the sequence 280 will terminate in the anomalous state. The prediction can also include a likelihood that the prediction is correct.

FIG. 2B is a diagram illustrating an example of Stochastic based determination according to the present disclosure. FIG. 2B includes a determination 210-1 whether that a sequence will terminate in an anomalous state and a determination 210-2 whether the sequence will terminate in a normal state, which are analogous to determination 210-1 and determination 210-2 in FIG. 2A. FIG. 2B also includes an early alert 220, no alert 222, and an end of the current time interval analysis 224.

An early alert 220 can be issued when it is determined 210-1 that the sequence will terminate in an anomalous state. An early alert 220 can be a message sent to IT personnel, e.g., user, and/or a message sent to other IT system components. A message can be in the form or a log entry, an e-mail, a text message, an output onto a screen, and/or any other form of communication. An early alert 220 can be early because the sequence is classified into an anomalous state before the alert is sent, e.g., before there is a problem. That is, an early alert 220 can be early because the sequence can be used to predict that a problem will arise before the problem is actually manifested in the vectors that compose the sequence.

For example, the sequence can enter a suspect state when a CPU usage, which is represented in the sequence, is greater than a threshold. The sequence can be used to query a first Stochastic Model and a second Stochastic Model model. A comparison of the results of the first Stochastic Model with the results of the second Stochastic Model can be used to determine 210-1 that the sequence will terminate in an anomalous state even though at the time that the determination 210-1 is made there is no loss of function associated with the application. The sequence can be classified as an anomalous state even though the application at the current time interval is functioning as expected. The classification 210-1 can be a prediction that the application in a future time interval will not function as expected and/or will experience a loss of function. The prediction can be based on a loss of function directly tied to the application and/or based on a loss of function due to a problem associated with the components that are associated with the application.

If it is determined 210-2 that the sequence will terminate in a normal state, then no action 222 may be taken. That is, it may be determined that IT personnel and/or an IT system component should not be alerted even though the sequence is in a suspect state.

The early alert 220 and/or the no action 222 can signify the end of a time interval analysis 224. The time interval analysis 200 can be performed at each time interval. For example, a first time interval analysis can be performed when the sequence includes a first sequence and a second sequence. A second time interval analysis can be performed when the sequence includes a first sequence, a second sequence, and a third sequence, and so forth. When no action 222 is taken, a time interval analysis can be repeated once the sequence is updated with a vector to determine whether the sequence with the new vector will terminate in an anomalous state. For example, a different vector can be accessed at each time interval and as a result the sequence can include a different combination of vectors because at each time interval a new vector is added to the sequence. The first Stochastic Model and the second Stochastic Model can be queried at each time interval and a determination can be made at each time interval. In a number of examples, the time interval associated with each of the vectors can be different than a time interval associated with the time interval analysis 200. For example, a time interval analysis 200 can be performed once per hour while each of the vectors can represent a time interval of one minute.

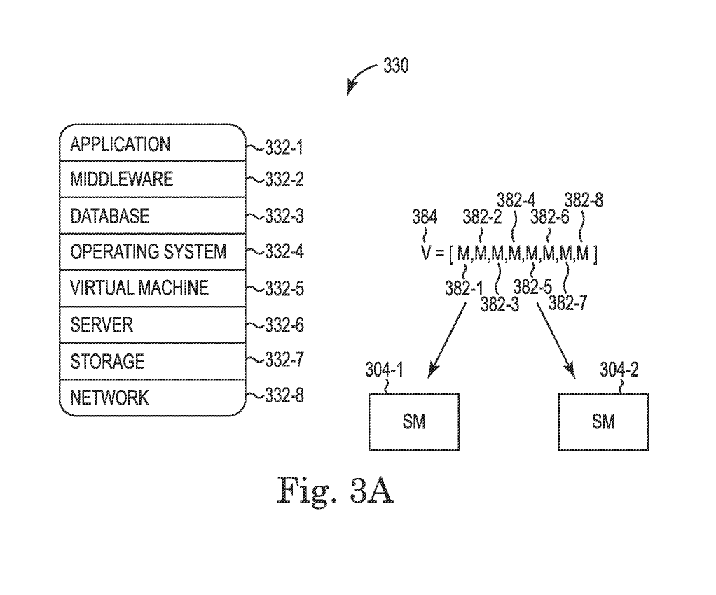

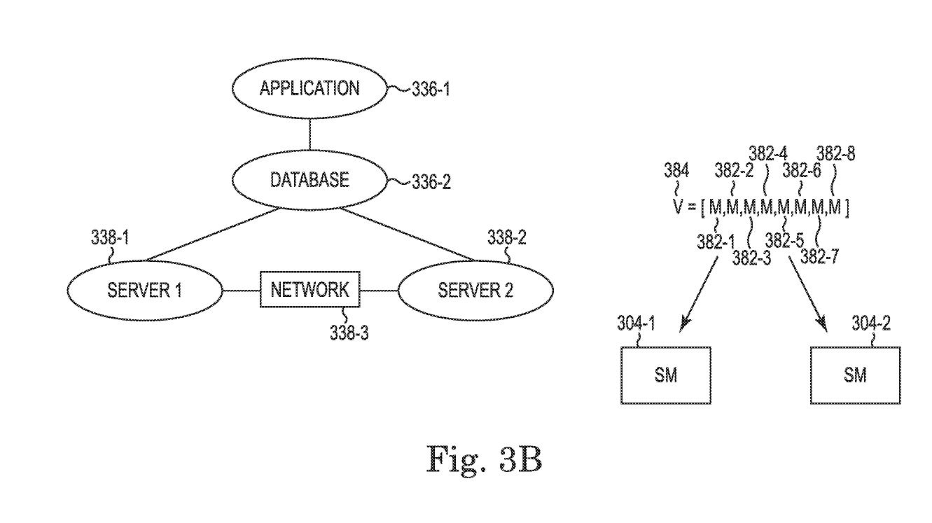

FIG. 3A is a diagram illustrating an example of a topology 330 of an application according to the present disclosure. In FIG. 3A, a topology 330 of an application can be associated with a vector 384 that includes a number of metrics. FIG. 3A also includes a first Stochastic Model 304-1 and a second Stochastic Model 304-2.

A topology 330 of an application can include the application 332-1 and a number of components that are associated with the application. For example, a component that is associated with the application can include middleware 332-2, a database 332-3, an operating system 332-4, a virtual machine 332-5, a server 332-6, a storage unit 332-7, and/or a network 332-8, e.g., referred to generally as components 332, among other components that can be associated with an application.

Each of the components can be associated with a number of metrics. For example, a server can be associated with a CPU usage and/or with a memory usage. In FIG. 3A, the application 332-1 can be associated with a metric 382-1, the middleware 332-2 can be associated with a metric 382-2, the database 332-3 can be associated with a metric 382-3, the operating system 332-4 can be associated with a metric 382-4, the virtual machine 332-5 can be associated with a metric 382-5, a server 332-6 can be associated with a metric 382-6, a storage unit 332-7 can be associated with a metric 382-7, and a network 332-8 can be associated with a metric 382-8, e.g., referred to generally as metrics 382.

The topology 330 of an application 332-1 can describe a number of dependencies between the application 332-1 and the number of components 332. For example, the application 332-1 can be running on the server 332-6. A dependency between the number of components 332 and the application 332-1 can further indicate that a loss of function in the components 332 can lead to a loss of function in the application 332-1. For example, if a database 332-3 is not functioning as expected, then an application 332-1 may lose database capabilities which may result in a loss of function in the application 332-1. The metrics 382 that are associated with the components 332 can define a performance of the application 332-1.

Metrics 382 can define a vector 384. Metrics 382 that are included in the vector 384 can define the performance of an application 332-1 at a given time interval. The metrics 382 can be collected and used in the time interval analysis that determines whether an application is classified as an anomalous state. The metrics 382, e.g., the vector 384, can be used in querying the first Stochastic Model 304-1 and the second Stochastic Model 304-2.

FIG. 3B is a diagram illustrating an example of a topology of an application according to the present disclosure. FIG. 3B includes a software component 336-1, a software component 336-2, a hardware component 338-1, a hardware component 338-2, and a hardware component 338-3. FIG. 3B also includes a vector 384 and a first Stochastic Model 304-1 and a second Stochastic Model 304-2 that are analogous to the vector 384, the first Stochastic Model 304-1, and the second Stochastic Model 304-2 in FIG. 3A.

The software component 336-1 can be an application while the software component 336-2 can be a database, e.g., referred to generally software components 336. The hardware component 338-1 can be a first server, the hardware component 338-2 can be a second server, and the hardware component 338-3 can be a network, e.g., referred to generally as hardware components 338.

FIG. 3B includes a metric 382-1, a metric 382-2, a metric 382-3, a metric 382-4, a metric 382-5, a metric 382-6, a metric 382-7, and a metric 382-8, e.g., referred to generally as metrics 382. In a number of examples, a component can be associated with a plurality of metrics. For example, a server, e.g., hardware component 338-1, can be associated with a metric 382-2 that can represent a CPU usage, and a metric 382-3 that can represent memory usage. In a number of examples, a metric can be associated with a number of components. For example, the metric 382-1 can represent query time that is associated with the time it takes for an application, e.g., software component 382-1, to request a query from the database, e.g., software component 382-2, to the time the database responds to the request. The metrics 382 in the form of a vector 384 can be used to query the first Stochastic Model 304-1 and to query the second Stochastic Model 304-2 when the vector 384 is in the form of a sequence.

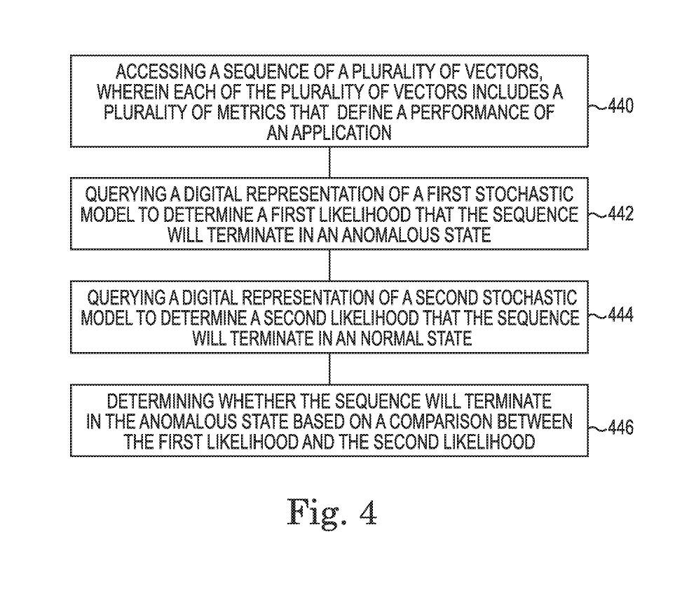

FIG. 4 is a flow chart illustrating an example of a method for Stochastic based determination according to the present disclosure. At 440, a sequence of a plurality of vectors, wherein each of the plurality of vectors includes a plurality of metrics that define a performance of an application, can be accessed. The plurality of metrics can define a performance of a number of components that are associated with a topology of the application. Each of the vectors can define the performance of the application during a respective time interval.

At 442, a first likelihood that the sequence will terminate in an anomalous state can be determined by querying a digital representation of a first Stochastic Model. In a number of examples, the sequence can be used to query the first Stochastic Model when the sequence transitions from a normal state to a suspect state. A first Stochastic Model can be queried by providing the sequence as input to the digital representation of the first Stochastic Model. The digital representation of the first Stochastic Model can be created using a number of sequences that have terminated in an anomalous state. That is, the first Stochastic Model, e.g., digital representation of the first Stochastic Model, can be created using a number of sequences that compose a history of the performance of an application wherein the sequences terminated in an anomalous state.

At 444, a second likelihood that the sequence will terminate in a normal state can be determined by querying a digital representation of a second Stochastic Model. In a number of examples, the sequence can be used to query the second Stochastic Model when the sequence transitions from a normal state to a suspect state. A digital representation of a second Stochastic Model can be queried by providing the sequence as input to the second Stochastic Model. A digital representation of a second Stochastic Model can be created using a number of sequences that have terminated in a normal state and/or that did not terminate in an anomalous state. That is, the second Stochastic Model can be created using a number of sequences that compose a history of sequences that terminated in a normal state and/or did not terminate in an anomalous state.

In a number of examples, a plurality of Stochastic Models can be used to determine the likelihood that a sequence will be classified as any of a number of states that can define the function of an application. For example, if the function of an application can be defined by four states, then a plurality of Stochastic Models that define the function of the application can include a first Stochastic Model, a second Stochastic Model, a third Stochastic Model, and/or a fourth Stochastic Model. Creating a number of Stochastic Models to represent a number of states can yield more accurate results than having a single Stochastic Model to represent a number of states. At 446, it can be determined whether the sequence will terminate in the anomalous state based on a comparison between the first likelihood and the second likelihood.

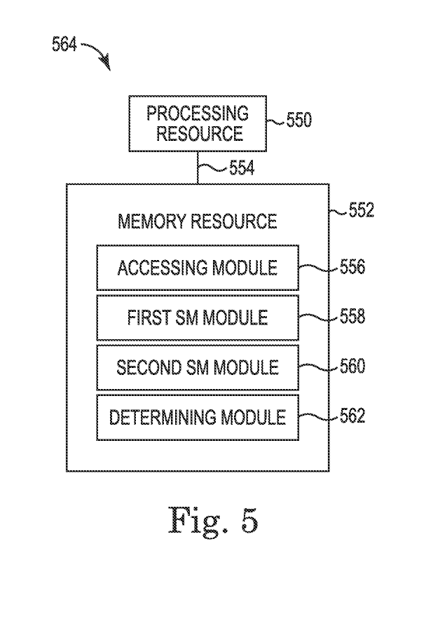

FIG. 5 is a diagram illustrating an example of a computing device according to the present disclosure. The computing device 564 can utilize software, hardware, firmware, and/or logic to perform a number of functions.

The computing device 564 can be a combination of hardware and program instructions configured to perform a number of functions, e.g., actions. The hardware, for example, can include one or more processing resources 550 and other memory resources 552, etc. The program instructions, e.g., machine-readable instructions (MRI), can include instructions stored on memory resource 552 to implement a particular function, e.g., an action such as a Stochastic based determination.

The processing resources 550 can be in communication with the memory resource 552 storing the set of MRI executable by one or more of the processing resources 550, as described herein. The MRI can also be stored in a remote memory managed by a server and represent an installation package that can be downloaded, installed and executed. A computing device 564, e.g., server, can include memory resources 552, and the processing resources 550 can be coupled to the memory resources 552 remotely in a cloud computing environment.

Processing resources 550 can execute MRI that can be stored on internal or external non-transitory memory 552. The processing resources 550 can execute MRI to perform various functions, e.g., acts, including the functions described herein among others.

As shown in FIG. 5, the MRI can be segmented into a number of modules, e.g., an accessing module 556, a first Stochastic Model module 558, a second Stochastic Model module 560, and a determining module 562, that when executed by the processing resource 550 can perform a number of functions. As used herein a module includes a set of instructions included to perform a particular task or action. The number of modules 556, 558, 560, and 562 can be sub-modules of other modules. For example, the first Stochastic Model module 558 and the second Stochastic Model module 560 can be sub-modules and/or contained within a single module. Furthermore, the number of modules 556, 558, 560, and 562 can comprise individual modules separate and distinct from one another.

In the example of FIG. 5, an accessing module 556 can comprise MRI that are executed by the processing resources 550 to access a sequence of a plurality of vectors, wherein each of the plurality of vectors includes a plurality of metrics that define a performance of an application, wherein each of the vectors is accessed at a different time interval.

A first Stochastic Model module 558 can comprise MRI that are executed by the processing resources 550 to query a digital representation of a first Stochastic Model to determine a first likelihood that the sequence will terminate in an anomalous state, wherein the first Stochastic Model is queried at each of a plurality of time intervals. A second Stochastic Model module 560 can comprise MRI that are executed by the processing resources 550 to query a digital representation of a second Stochastic Model to determine a second likelihood that the sequence will terminate in a normal state, wherein the second Stochastic Model is queried at each of the plurality of time intervals.

A determining module 562 can comprise MRI that are executed by the processing resources 550 to determine whether the sequence will terminate in the anomalous state based on a comparison between the first likelihood and the second likelihood at each of the time intervals. A determination can be made at each time interval whether the first likelihood or the second likelihood is greater than the first threshold, e.g., A threshold.

A determination can be made that the sequence will terminate in the anomalous state based on the determination that the first likelihood is greater than a first threshold, e.g., A threshold. For example, if a first threshold, e.g., A threshold, is 95%, then a determination can be made that the sequence will terminate in the anomalous state based on the determination that the first likelihood is greater than 95%. In a number of examples, a determination that the sequence will terminate in the anomalous state can be made when the first likelihood is greater than 95% before the second likelihood is greater than 95%.

Instructions to determine that the sequence will terminate in the anomalous state include instruction to determine that the sequence will terminate in the anomalous state based on a determination that the difference between the first likelihood and the second likelihood is greater than a second threshold, e.g., B threshold. For example, if a second threshold, e.g., B threshold, is 15%, then a determination that the sequence will terminate in the anomalous state can be made if the first likelihood is 80% and the second likelihood is 50% because the different between 80% and 50% is greater than 15%.

Instructions to determine that the sequence will terminate in the anomalous state can include instruction to determine whether a length of the sequence is greater than a third threshold, e.g., C threshold. A length of the sequence can be a precursor to a determination that the sequence will terminate in an anomalous state or in a normal state. The length of a sequence can be determined by the number of instances of metrics that are represented in the number of vectors that compose the sequence. In a number of examples, the length of a sequence can be determined by the number of vectors in a sequence. A third threshold, e.g., C threshold, can include, for example, ten vectors. The third threshold, e.g., C threshold, can be associated with the time that a problem, that is associated with the application, takes to develop and/or with the length of the time intervals that are associated with the sequences of metrics.

Instructions to determine that the sequence will terminate in the anomalous state can include instruction to determine that the sequence will terminate in the anomalous state when it is determined that the length of the sequence is greater than the third threshold, e.g., C threshold, and when the first likelihood is greater than the second likelihood. For example, if the third threshold, e.g., C threshold, is two hundred vectors, the first likelihood is 90%, and the second likelihood is 45%, then a determination that the sequence will terminate in an anomalous state can be made when the number of vectors in a sequence is greater than two hundred because the first likelihood, e.g., 90%, is greater than the second likelihood, e.g., 45%.

A memory resource 552, as used herein, can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The memory resource 552 can be integral or communicatively coupled to a computing device in a wired and/or wireless manner. For example, the memory resource 552 can be an internal memory, a portable memory, and a portable disk, or a memory associated with another computing resource, e.g., enabling machine readable instructions (MRIs) to be transferred and/or executed across a network such as the Internet.

The memory resource 552 can be in communication with the processing resources 550 via a communication path 554. The communication path 554 can be local or remote to a machine, e.g., a computer, associated with the processing resources 550. Examples of a local communication path 554 can include an electronic bus internal to a machine, e.g., a computer, where the memory resource 552 is one of volatile, non-volatile, fixed, and/or removable storage medium in communication with the processing resources 550 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 554 can be such that the memory resource 552 is remote from a processing resource, e.g., processing resources 550, such as in a network connection between the memory resource 552 and the processing resource, e.g., processing resources 550. That is, the communication path 554 can be a network connection. Examples of such a network connection can include local area network (LAN), wide area network (WAN), personal area network (PAN), and the Internet, among others. In such examples, the memory resource 552 can be associated with a first computing device and the processing resources 550 can be associated with a second computing device, e.g., a Java® server. For example, processing resources 550 can be in communication with a memory resource 552, wherein the memory resource 552 includes a set of instructions and wherein the processing resources 550 are designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for Stochastic based determination comprising:
accessing a sequence of a plurality of vectors, wherein each of the plurality of vectors includes a plurality of metrics that define a performance of an application;
querying a digital representation of a first Stochastic Model to determine a first likelihood that the sequence will terminate in an anomalous state;
querying a digital representation of a second Stochastic Model to determine a second likelihood that the sequence will terminate in a normal state; and
determining whether the sequence will terminate in the anomalous state based on a comparison between the first likelihood and the second likelihood.

2. The method of claim 1, wherein the sequence is used to query the first Stochastic Model and the second Stochastic Model when the sequence has not been determined to terminate in the anomalous state.

3. The method of claim 1, wherein each of the plurality of metrics defines a performance of a component of a topology of the application, wherein the topology of the application defines a plurality of components that are associated with the application.

4. The method of claim 1, wherein the sequence defines the performance of an application during a number of time intervals.

5. The method of claim 1, wherein the sequence of metrics is accessed when the sequence transitions from a normal state to a suspect state.

6. A non-transitory machine-readable medium storing instructions for Stochastic based determination executable by a machine to cause the machine to:
access a partial sequence of a plurality of vectors, wherein each of the plurality of vectors includes a plurality of metrics that define a performance of an application;
query a digital representation of a first Stochastic Model to determine a first likelihood that the partial sequence will terminate in an anomalous state;
query a digital representation of a second Stochastic Model to determine a second likelihood that the partial sequence will terminate in a normal state;
classify the partial sequence as anomalous when it is determined that the partial sequence will terminate in the anomalous state, wherein a determination is based on a comparison between the first likelihood and the second likelihood; and
provide an alert that the partial sequence is expected to terminate in the anomalous state.

7. The medium of claim 6, wherein the instructions executable to access the partial sequence include instructions to access the partial sequence that has not terminated.

8. The medium of claim 6, wherein the instructions executable to query the first Stochastic Model and the second Stochastic Model include instructions to provide the partial sequence as input to the first Stochastic Model and the second Stochastic Model.

9. The medium of claim 6, wherein the instructions executable to classify the partial sequence as anomalous include instructions to determine that the sequence of metrics will terminate in the anomalous state when the first likelihood is greater than the second likelihood.

10. The medium of claim 6, wherein the instructions are executable to create the digital representation of the first Stochastic Model with a first number of sequences that terminated in the anomalous state and create the digital representation of the second Stochastic Model with a second number of sequences that terminated in the normal state.

11. The medium of claim 10, wherein the first number of sequences that terminated in the anomalous state have varying numbers of vectors and wherein the second number of sequences that terminated in the normal state have varying numbers of vectors.

12. A computing device, comprising:
a processing resource in communication with a memory resource, wherein the memory resource includes:
an accessing module including instructions to access a sequence of a plurality of vectors, wherein each of the plurality of vectors includes a plurality of metrics that define a performance of an application, wherein each of the vectors is accessed at a different time interval;
a first Stochastic Model module including instructions to query a digital representation of a first Stochastic Model to determine a first likelihood that the sequence will terminate in an anomalous state, wherein the first Stochastic Model is queried at each of a plurality of time intervals;
a second Stochastic Model module including instructions to query a digital representation of a second Stochastic Model to determine a second likelihood that the sequence will terminate in a normal state, wherein the second Stochastic Model is queried at each of the plurality of time intervals; and
a determining module including instructions to determine whether the sequence will terminate in the anomalous state based on a comparison between the first likelihood and the second likelihood at each of the time intervals wherein:
a determination is made at each time interval whether the first likelihood or the second likelihood is greater than the first threshold; and
a determination is made that the sequence will terminate in the anomalous state based on the determination that the first likelihood is greater than the first threshold.

13. The device of claim 12, wherein the instructions to determine that the sequences will terminate in the anomalous state include instructions to determine that the sequence will terminate in the anomalous state based on a determination that the difference between the first likelihood and the second likelihood is greater than a second threshold.

14. The device of claim 12, wherein the instructions to determine that the sequence will terminate in the anomalous state include instructions to determine whether a length of the sequence is greater than a third threshold.

15. The system of claim 14, wherein the instructions to determine that the sequence will terminate in the anomalous state include instructions to determine that the sequence of metrics will terminate in the anomalous state when it is determined that the plurality of vectors is greater than the third threshold and when the first likelihood is greater than the second likelihood.
